(19) United States
(12) Patent Application Publication
(10) Pub. No.: US 2023/0336054 A1
(43) Pub. Date: Oct. 19, 2023

(54) POWERING AND RECHARGING LONG RANGE ELECTRIC VEHICLES

(71) Applicant: Michael Curtis Grayson, Bolivar, TN (US)

(72) Inventor: Michael Curtis Grayson, Bolivar, TN (US)

(21) Appl. No.: 18/212,420

(22) Filed: Jun. 21, 2023

Related U.S. Application Data
(63) Continuation-in-part of application No. 17/868,939, filed on Jul. 20, 2022.
Application No. 17/868,939 is a continuation of application No. 17/590,779, filed on Feb. 1, 2022.
Application No. 17/590,779 is a continuation of application No. 16/801,505, filed on Feb. 26, 2020, now abandoned.
(60) Provisional application No. 63/259,492, filed on Jul. 20, 2021.

(51) Int. Cl. H02K 7/18; H02J 7/00; B60L 53/50; B60L 50/90; H02K 11/00; B60L 53/60

(52) U.S. Cl. CPC H02K 7/1846; H02J 7/007; B60L 53/50; B60L 50/90; H02K 11/0094; B60L 53/60

(57) ABSTRACT

An electric vehicle powered and recharged by multiple redundant independent kinetic energy charging systems to ensure extended operation of the vehicle. While driving, each kinetic energy charging system is responsive to wheel rotation for generating electricity for storage thereof at the vehicle. Redundant kinetic energy charging systems include: a Center Hub kinetic recharger system, a Rear Hub kinetic recharger system, and a Hubless Tire kinetic recharger system. The power generated from each charging system is routed to a smart charge combiner to combine generated electricity output and a smart ultracapacitor energy storage system that stores combined electricity output. The stored charge can power a vehicle battery or battery bank under control of a smart charge controller to extend an operating range of the vehicle without recharging. The ultracapacitor storage system is configured in a portable energy storage unit removable from the vehicle and adapted for delivering electricity to other devices.

### PRIORITY

This application is a continuation-in-part of co-pending U.S. patent application Ser. No. 17/868,939 (41164Z) filed with the U.S. Patent and Trademark Office on Jul. 20, 2022 which claims the benefit of U.S. Provisional Patent Application No. 63/259,492 filed with the U.S. Patent and Trademark Office on Jul. 20, 2021, the entire contents of which is incorporated herein by reference. This application also claims benefit of U.S. patent application Ser. No. 17/590,779 (40784Z) filed with the U.S. Patent and Trademark Office on Feb. 1, 2022 which is a continuation of and claims the benefit of U.S. patent application Ser. No. 16/801,505 filed with the U.S. Patent and Trademark Office on Feb. 26, 2020, the entire contents of both of which is incorporated herein by reference.

### FIELD

The present invention relates generally to vehicle electronics generally, and particularly systems and methods for harnessing kinetic energy for use in powering and recharging wheeled electric vehicles such as automobiles, trucks, busses, bicycles, and the like, and, more particularly, an Advanced Kinetic Energy Recovery System (AKERS) type range extenders and recharging methods for electric vehicles for dramatically increasing a vehicle's operating range and greatly reducing or eliminating the need for recharging.

### BACKGROUND

Although pure electric vehicles have the advantage of energy-savings, environmental protection, and zero discharge, the continual mileage range is currently very limited. In order to achieve mass application and acceptance the electric vehicle range must meet or exceed that of conventional fossil fuel powered vehicle. Currently 300 miles is the average range for an electric vehicle with hypermiling. This range makes electric long-range travel very limited and impractical for most applications. It would be very easy to give the vehicle a higher range, just by equipping the vehicle with a bigger battery. However, for electric vehicles, the solution is not as simple. Adding more battery as the solution for perceived range needs only adds more cost to the profitability-challenged electrified vehicle but more importantly makes a weight sensitive vehicle only a dream of the future. More mass on the vehicle is unacceptable. Batteries are very heavy and dangerous. In order to meet very stringent fuel economy and CO₂ targets globally (e.g., China, Europe, US and CA), all vehicles will have to be lighter and more mass efficient. OEM's will pay more in premium materials for weight savings. Adding 4 lbs. of battery mass is roughly equal to 1 mile of range.

EVs suffer from longer charging times to top-off. Charging infrastructure for long distance trips are currently under development, however, no solution is close at hand. The larger the batteries become, the faster charging solutions that are required and continuous high-power fast-charging will increase battery degradation and lower safety.

EVs require more structural requirements for crashworthiness. We are often reminded that both gas tanks and batteries contain so much energy and they need to be carefully protected from thermal events that can occur during crashes. Larger batteries are greater engineering challenges requiring more substantive structures/systems. As the battery grows and the mass of the vehicle increases, other components from frame components, suspension system, thermal management, etc. must be redesigned and reinforced to handle these challenges; the result is even more mass and cost added to the vehicle.

### SUMMARY

In one aspect, there is provided Grayson Kinetic Recharger (GKR) electric power generation systems and methods that address each and every one of the aforementioned problems in a practical, reliable, and cost-effective way for increasing and extending the range of electric vehicles.

A series of high efficiency Advanced Kinetic Energy Recovery Systems (AKERS) type range extenders and rechargers for electric vehicles that dramatically increase the electric vehicle range, dramatically reduce the need for recharging, diminish the need for large batteries, reduce the need for large recharging networks making electric transportation more universally available, and increase the safety of the vehicle, effectively lowering the sprung weight of the vehicle, and speeding up recharge times.

Embodiments provide an electric vehicle charging system that includes improved operating safety gains exponential range extension, provide more power for greater engine power, and create a platform that will have immediate and long-term environmental benefits while simultaneously reducing charging times, improving overall efficiency.

In aspect, there is provided one or more electric vehicle battery recharging systems that greatly extends the range of an electric vehicle, the recharging systems configurable as a series of range extender and recharger systems for electric vehicles, dramatically increasing the driving range and greatly reducing or eliminating the need for recharging. These device(s) are referred to as a Grayson Kinetic Recharger (GKR). These systems provide a plurality of charging systems to add redundancy of charging. Redundancies are provided in the electric vehicle systems in order to provide good safety. Because these systems can be attached at numerous places on the subject electric vehicle this design is modular and scalable, the power produced is customizable to the desired recharge time and range. The range extender (AKERS) is characterized in that it comprises at least three (3) redundant kinetic recharging systems: a Center Hub kinetic recharger system, a Rear Hub kinetic recharger system, and a Hubless Tire kinetic recharger system.

According to an embodiment, there is provided, a power generation system for an electric vehicle. The power generation system for an electric or hybrid comprises: one or more first electrical machine generator systems connected at a center hub of a corresponding one or more rotating wheels of the vehicle, each respective one or more first electrical machine generator systems for generating electricity responsive to kinetic energy of the respective corresponding rotating wheel; and one or more second electrical machine generator systems connected at a tire rim assembly of a corresponding one or more rotating wheels of the vehicle, each respective one or more second electrical machine generator systems for generating electricity responsive to kinetic energy of the respective corresponding rotating wheel; and an energy storage and delivery system adapted to receive generated electricity from each of the one or more first electrical machine generator systems and second electrical machine generator systems, store the generated electricity as charge corresponding to concentrated voltage or current received from the first electrical and second electrical machine generators, and deliver stored charge as electric power for use by the vehicle.

According to a further embodiment, there is provided a portable power supply system. The portable power supply system comprises: a portable energy storage unit adapted for storage in a vehicle and removal from the vehicle, the portable energy storage unit comprising: a self-cooling ultracapacitor energy storage device controllable by a hardware processor device to receive and store electricity received from multiple redundant energy recharger devices disposed in a vehicle that convert kinetic energy of a respective rotating vehicle wheel into generated electricity; a first electrical connector for electrically connecting the ultracapacitor energy storage device to an output of the multiple redundant energy recharger devices for receiving the electricity generated from multiple redundant energy recharger devices at the respective rotating vehicle wheel; and one or more second electrical connectors for electrically connecting the portable energy storage unit to another device, said portable energy storage unit adapted to power up another device by delivering stored charge from the ultracapacitor storage device the portable energy storage unit is to the another device when the portable energy storage unit is removed from the vehicle.

The present invention provides a modular scalable advanced kinetic energy recharging system for electric vehicles that can be disposed at numerous places on the subject vehicle and the power produced by each is combinable to provide a constant high volume of charge sufficient to sustain an electric vehicle travel for distances of over 1000 miles without recharging.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of some embodiments and do not limit the disclosure.

FIG. 1 depicts an exploded view of a first kinetic recharger center hub energy generation system for an electric vehicle;

FIG. 2 is a view showing dimensions of a final assembly of the center hub energy generation system of FIG. 1;

FIG. 3A shows a conceptual view of the center hub energy generation system of FIG. 1 showing a first phased positioning of copper coil-winding of outer stator relative to the positioning of corresponding copper coil-windings of inner stator and the center rotor magnet therebetween according to an embodiment;

FIG. 3B shows a conceptual view of the center hub energy generation system of FIG. 1 showing a second phased positioning of copper coil-winding of outer stator relative to the positioning of corresponding copper coil-windings of inner stator and the center rotor magnet therebetween according to an embodiment;

FIG. 3C shows a conceptual view of the center hub energy generation system of FIG. 1 showing a third phased positioning of copper coil-winding of outer stator relative to the positioning of corresponding copper coil-windings of inner stator and the center rotor magnet therebetween according to an embodiment;

FIG. 3D shows a further conceptual view of the center hub energy generation system of FIG. 1 showing a further phased position in which the two-stator system is configured to provide for a pulsed drag reduction strategy according to an embodiment;

FIG. 4 depicts an exploded view of a second first kinetic recharger rear hub energy generation system for an electric vehicle;

FIG. 5 shows an exploded view of the second first kinetic recharger rear hub energy generation system attached to a center hub of a standard wheel via wheel spacer bolts.

FIG. 6A shows a view of dynamic recapture configuration positions of rotor magnets at the rotor in the second first kinetic recharger rear hub energy generation system according to an embodiment;

FIG. 6B depicts a further conceptual cross-sectional view of a dynamic recapture magnetic field structure and method for creating alternating magnetic field directions induced by interaction of rotor magnets and two-stator system to increase the amount of charge produced by the second first kinetic recharger rear hub energy generation system in an embodiment;

FIG. 7A-7C depicts various views of a rotor assembly for use in the kinetic recharger energy generation system according to a further embodiment;

FIG. 8 depicts an exploded view of a third kinetic recharger rear hub energy generation system for an electric vehicle;

FIG. 9 depicts an electric powered vehicle such as an electric bicycle equipped with an assembled third kinetic recharger rear hub energy generation system of FIG. 8 in an embodiment;

FIG. 10 depicts a portion of an electric powered vehicle equipped with a PowerBox Trunk Unit storing removable and portable powerbox devices housing ultracapacitor storage devices storing charges;

FIG. 11A depicts a view of the PowerBox wherein the device has multiple electrical sockets or interfaces for providing AC or DC electricity depending on the configuration to plug in appliances, equipment, and accessories in an embodiment;

FIG. 11B depicts an embodiment of the PowerBox including the provision of plural ultracapacitor storage devices for storing generated energy in an embodiment;

FIG. 12 shows a PowerBox charge cable extension cord which is a universal charge cable having one end adapted to be connected to a powerbox socket and having a second end with a suitable probe or connector adapted for connection to another vehicle or device to recharge other vehicles/devices in an embodiment;

FIG. 13 depicts a Nano Grid apparatus employing PowerBox battery storage systems for a home unit that allows for power inputs, e.g., received from vehicles and other additional power sources such as solar, wind in an embodiment;

FIG. 14 depicts a home equipped with a Nano Grid system or unit employing a home powerbox unit of FIG. 13 having one or more PowerBox units in an embodiment;

FIG. 15 depicts a Nano Grid management Network employing the PowerBox home unit configured to receive input from various energy generation units or provide power back to various devices such as a battery or nanogrid electrical network in an embodiment; and

FIG. 16 shows an embodiment of a Smart Charge Controller system for a vehicle to store charge generated by one or more redundant independent energy recharging systems in the vehicle.

### DETAILED DESCRIPTION

Embodiments of the invention provide systems and methods for electrical energy generation for extending the range of an electric vehicle, particularly, redundant recharging systems for extending the range of an electric vehicle or any vehicle powered in whole or in part by electricity driven engines, or similar hybrid fuel/electric engines, battery-powered electric vehicle (BEV); the hybrid electric vehicle (HEV); and the plug-in hybrid electric vehicle (PHEV), fuel hybrid electric vehicle (FHEV), mild hybrid electric vehicle (MHEV), fuel cell fuel electric vehicle (FCEV), internal combustion engine (ICE), all forms of transportation or wheeled vehicles, in addition electric equipment or machinery such as toy cars, roller coasters, assembly lines, electric drones, wheelchair, exercise bike, escalator, and turbines.

In aspect, there is provided an electric vehicle powered and recharged by multiple redundant independent charging systems to ensure extended operation of the vehicle. All systems are configured as redundant electrical energy charging systems responsive to kinetic energy, such as produced from motion of wheels, for generating electricity and are operatively combined to provide a constant high volume of charge sufficient to sustain operation of the vehicle to enable vehicle travel in excess of 1000 miles without having to recharge. The multiple redundant independent charging systems includes three advanced kinetic energy recovery systems including: a Center Hub kinetic recharger system, a Rear Hub kinetic recharger system, and a Hubless Tire kinetic recharger system. Because these systems can be attached at numerous places on the subject vehicle this design is modular and scalable, the power produced is customizable to the desired recharge time and range. The power from each machine system is routed to a smart charge combiner, a smart high-voltage ultracapacitor storage system, then a vehicle battery or battery bank under control of a smart charge controller.

Embodiments herein describe multiple ways to configure an electric vehicle with these AKERS electrical energy generation range extending systems. All systems can work together simultaneously or in various combinations to provide a constant high volume of charge sufficient to sustain an electric vehicle travel for greater distances without recharging.

A first vehicle electrical energy generator system (e.g., System 1) is configured to provide kinetic energy for recharging systems for extending the range of any electric vehicle is a Center Hub kinetic recharger system. As referred to herein, an electric vehicle can include, but is not limited to a personal vehicle, personal transportation, such as electric carts, hoverboards, roller skates, skateboards, bikes, any moving vehicle, electric mopeds, golf kart, trailers, wagons, scooter, a car or automobile, a motorcycle, an electric bicycle, and a commercial vehicle such as a truck, trains, bus, semis, or bus.

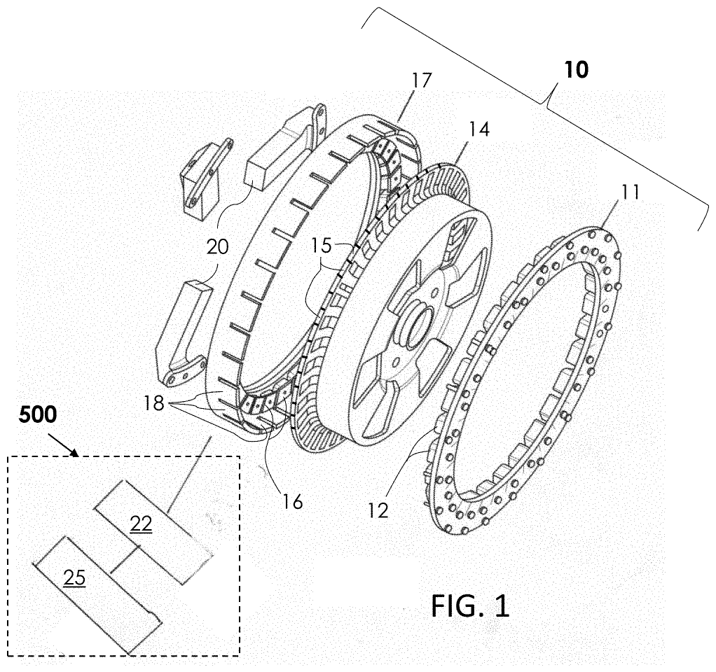

FIG. 1 is a view of an exemplary exploded sectional view of a Center Hub generator kinetic recharger system 10 (e.g., System 1) including configured to provide kinetic energy for electric vehicle battery recharging systems. This first system 10 includes an assembly having a metal outer stator ring 11 which can include one or more wire-wound metal (e.g., copper) coils 12; a metal center ring rotor cap 14 having magnets on a surface thereof; a metal inner stator ring 17 which can include one or more wire-wound metal coils 16 on an inner surface and includes a plurality of peripherally mounted stator coils 18 about a circumferential periphery of the stator ring 17. When assembled, the two side rotors 11 and 17 and the peripherally mounted stator coils 18 (acting as a third stator) about a circumferential periphery of the stator ring 17 encapsulate the center rotor 14 to maximize energy generation. Additionally shown is a mounting harness 20 to which stator element 17 is mounted to the vehicle. The housing also holds a series of small rectangular magnets (not shown) on the outer rim. The stators 11 and 17 are located on either side of the rotor 14 and encompasses the entire perimeter of the rotor such that, in an embodiment, both sides of ring rotor 14 includes permanent magnets (PMs) and at a peripheral edge include further rectangular peripheral magnets 15 that interact with the peripherally mounted stator coils 18. This rotor-stator assembly completely encompasses the magnetic fields in every direction and creates a comprehensive stator enclosure around the rotor. As further shown in FIG. 1 is a smart charge controller/combiner 22 for receiving generated electrical energy, and a smart ultracapacitor 25 for storing generated charge. Generally, in each kinetic recharger system, magnetic fields are created through electric current in the wire-wound coil as the rotor magnet rotates relative to the metal wire-coil stators. Each kinetic recharger device includes output from which the generated charges are extracted and conveyed as electric current to the smart combiner which in turn passes the current to the smart ultracapacitor for storage thereof.

In an embodiment shown in FIG. 1, the smart charge/combiner 22 and the smart ultracapacitor 25 components are both housed in a separate removable and portable “PowerBox” unit 500 which is a removable portable power source which houses the smart charge computer combiner and the ultracapacitor. As will be described, the PowerBox is a removable power source that can be used to power the same vehicle, other vehicles, appliances, accessories, equipment, power a home or integrated within a nanogrid system.

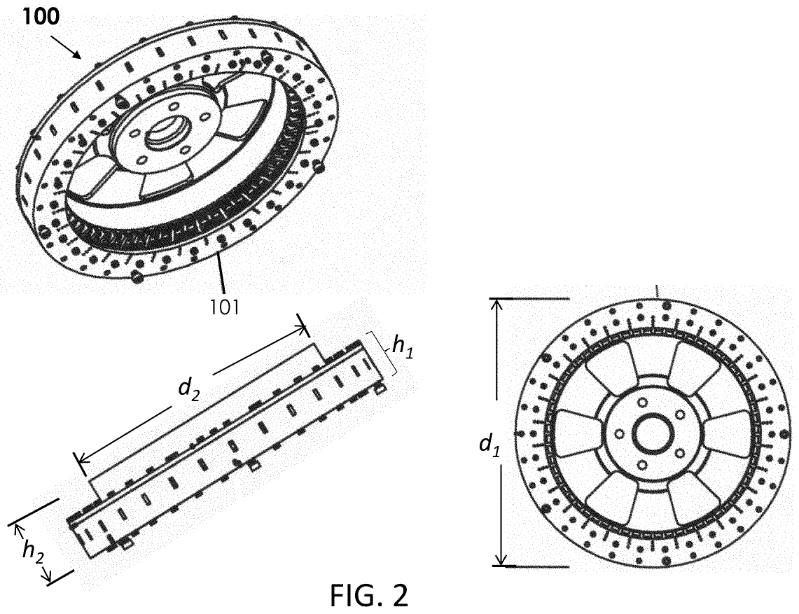

FIG. 2 is a view of the sample GKR Center Hub Generator device final assembly 100 of the Center Hub Generator device of FIG. 1. Here the stator is affixed to the device housing that is connected to the control arm harness, only the wheel and rotor are allowed to move freely in this device. The assembled GKR Center Hub Generator device assembly 100 is configured to be compatible with any existing vehicle wheel dimension, and in a non-limiting example embodiment, has an outer stator ring diameter d₁ of approximately 457 mm and a total height h₁ of about 56.33 mm. The center rotor cap 14 is of a diameter d₂ of about 352 mm and a height h₂ of about 89.73 mm.

This assembled generator system 100 attaches to the hard points of a vehicle wheel assembly, i.e., “hard points” referring to the attachment points that are fixed to the vehicle and are (essentially) unalterable, aside from cutting and welding. As this generator unit is designed to attach to the hard points means that the integration of this unit can be done aftermarket which means that OEMs do not have to invest large sums of money into the redesigning their existing vehicle platform.

The assembled GKR generator system 100 further integrates easily into existing vehicle systems by attaching it to a tire rim such as shown in FIG. 2 where an outer lip of the rim is attached to the rim using clamps (not shown). The dimensions of the device are constructed so that they can be easily integrated into any vehicle wheel assembly as shown in millimeters in FIG. 2. Once the vehicle tires start to rotate it turns the rotor. The rotor then induces a current into both the inner and outer stator copper coils. The current is then directed to the smart charge/combiner 22 and the smart ultracapacitor 25 in the power box 500.

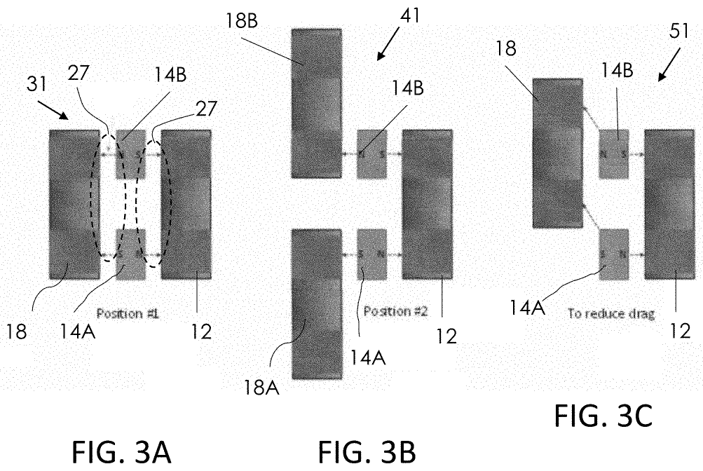

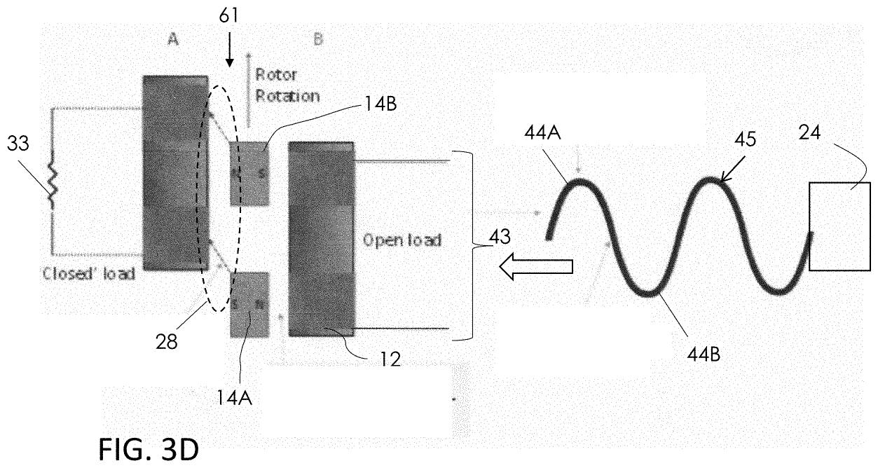

In an embodiment, the first GKR Center Hub Generator (CHG) system 10 of FIG. 1 configured as a two-stator system, the outer stator 11 and an inner stator 17 are placed in a phased position, i.e., even though the two stators are not connected they still used the same rotor and therefore their magnetic fields interact and are connected. In order for this type of system to maximize the charge efficiency it is important to shift the stator rings so that the copper windings of each are not directly across from each other. Having the two stator windings directly across from each other will create and attractive force that will resist the forward movement of the device and thereby create a back force in the opposite direction as represented by FIG. 3A. By realigning the relative positions as shown in FIGS. 3B-3D it is possible to use this force to actually increase the forward force and thereby increase the current. In addition, the system pulses the coils by a timed application of a pulse of electricity through the driver coils only to turn them into electromagnets so that they will repulse the permanent magnets on the outside rim of the rotor disc. In an embodiment, the application of pulses of electricity is in an on and off to remove any drag or back EMF to promote maximum charge. This total process is called phase shifting the stators to maximize the force of the central rotor 14 on both stators.

FIGS. 3A-3C depict a GKR Center Hub Generator device with the outer stator ring and inner stator ring and their corresponding copper coils 12 and 18 at respective different (phased) positions 31, 41 and 51 relative to each other. In a first phased position 21 shown in FIG. 3A, both stator coil windings 12 and 18 of the two-stator system are in direct alignment with the rotor magnets 14A, 14B of rotor in the center. The attractive forces created by this phased position will cause drag on the system as the attraction bonds, have to be broken which will lower the current output.

In a second phased position 41 shown in FIG. 3B, stator coil windings 12 and 18 the two-stator system are out of direct alignment. In FIG. 3B, the two copper coil windings 18A, 18B positioned on the stator are not directly lined up with the second stator single Copper coil winding 12.

In a third phased position 51 shown in FIG. 3C the two-stator system provides an out of phase drag reduction. In this third phased position 51, the rotor magnets 14A, 14B push the copper coil along in first stator coil 18 while attracting the copper coil in second stator coil 12, which is the optimal arrangement in a two-stator system.

FIG. 3D shows a further phased position 61 in which the two-stator system provides a pulse drag reduction strategy. In FIG. 3D, two-stator system implements a second part of the drag reduction process whereby the coils are shut off periodically to reduce the amount of current built up in the stator coils 12 and 18. Here, stator coil 18 is shown attached to a “closed”, i.e., attached load represented by a resistor 33. Because of the relative small size of the coils 12 and 18, charge builds up in the wires and the stator coils themselves behave as magnets and produce attractive forces 28, i.e., of stator coil 18 pushing inside rotor forward. These magnets have their own attractive forces that then must be overcome. As the attractive force 28 shuts off with no load or an open load-resulting in no drag, the current through attached load 33 can be controlled by applying pulse control signals using a pulse generator 24 to control opening and closing connection to the load connection 43 at stator coil 12. Here a pulse generator controls a transistor switch (not shown) connected to the second stator coil 12 load connections 43 that receives control signal 45 used to pulse the coils. The applied pulse timing of signal 45 is controlled in a manner such that the coils never have an opportunity to build up charge therefore there are no attractive forces to overcome. For example, a signal portion 44A can control switching in of the load such that no current is provided to load 33 however will control provision of current provided to a load connected at stator coil 12 while a further pulse signal portion 44B the of control signal 45 can control switching in of the load such that current is provided to load 33 however no current will be provided to a load connected at stator coil 12.

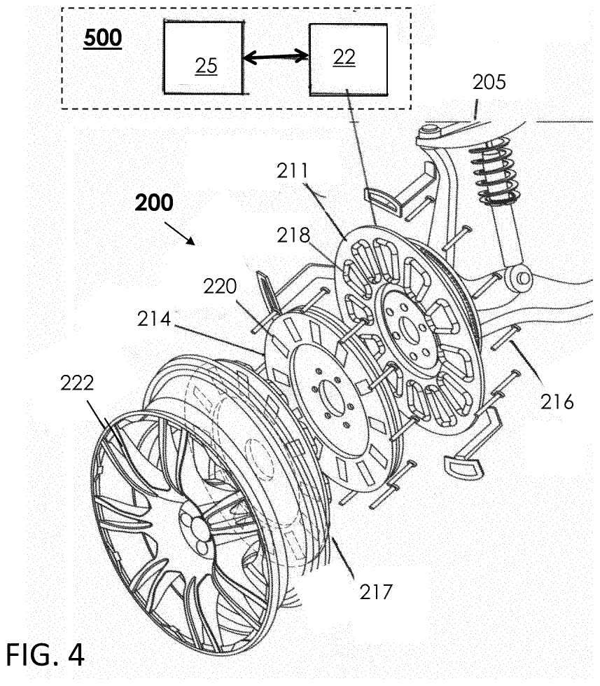

FIG. 4 depicts an exploded view of a second GKR Rear Hub Generator (RHG) Device (system 2) 200 according to a further embodiment. The Rear Hub Generator 200 consists of an Inner Oval Stator 211 having large oval copper coils 218 designed to concentrate the coil windings using heavy gauge wiring, a rotor 214, a dynamic recapture magnetic field structure 220. In the embodiment of FIG. 4, the dynamic recapture magnetic field structure 220 on the rotor 214 refers to the positioning and shape of the permanent magnets themselves to control the magnetic field, and an outer oval Stator 217. This system 200 attaches to a vehicle wheel rim 222 with spokes. This system 200 is further attached to a vehicle control arm harness assembly 205. The system 200 further employs Smart Electronic Shim Spacers 216 to control a spacing between the rotors 214 and each of the inner and outer stators 211 and 217. In particular, the distance between the rotor and each of the stators is electronically controlled by a computer or processor-based controller that configures the smart spacer device 216 to in order to maximize charge characteristics (to achieve maximum power output) and to minimize heat generation or maximize cooling.

As further shown in FIG. 4 is the smart charge controller/combiner 22 for receiving generated electrical energy, and the smart ultracapacitor 25 for storing generated charge housed in the power box 500 in an embodiment. Once the vehicle tires start to rotate it turns the rotor. The rotor then induces a current into both the inner and outer stator copper coils 211, 217. The generated current is then directed to the smart charge/combiner 22 and the smart ultracapacitor 25 in the removable/portable power box 500.

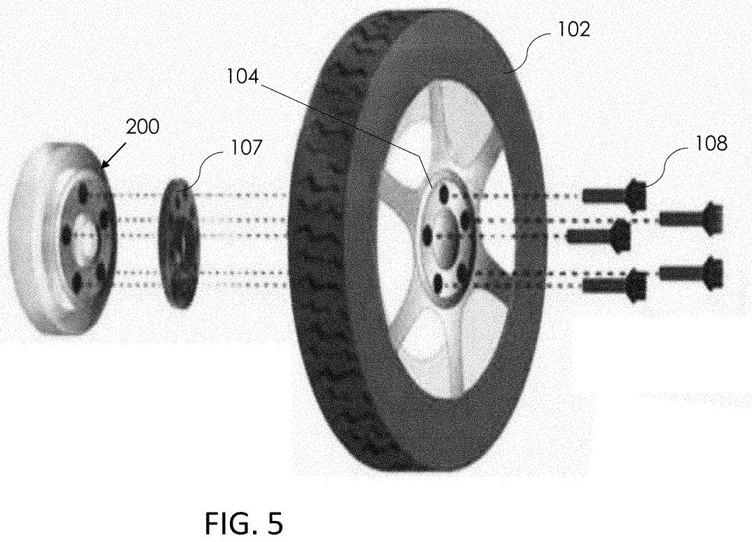

FIG. 5 shows an exploded view of the System 2 GKR Rear wheel Hub Generator (RHG) device 200 attached to a center hub 104 of a standard wheel 102, and is particularly shown connected to the wheel center hub through a wheel spacer via wheel bolts 108.

In an embodiment, the System 2 GKR Rear Hub Generator (RHG) assembly 300 shown in FIG. 4 is configured such that the device attaches to the control arm 205 of the vehicle. The at least two stators 211, 217 each have large oval copper windings 218 attached. There is at least one dynamic recapture permanent magnet rotor 214 with magnets 220 attached to both side surfaces that are placed and shaped to create a field the comes back on itself. That is, the shape and placement of the magnets concentrates the magnetic field so that it is directed back towards the magnet as a result of repulsive forces, rather than dissipate.

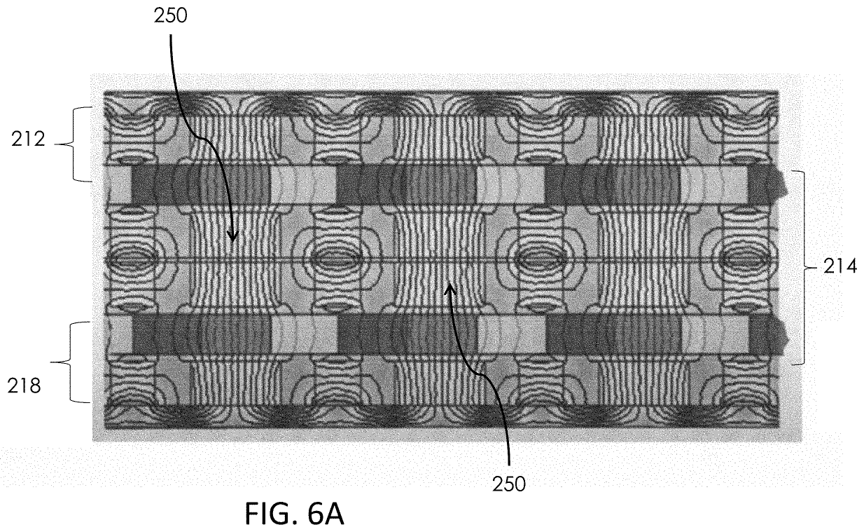

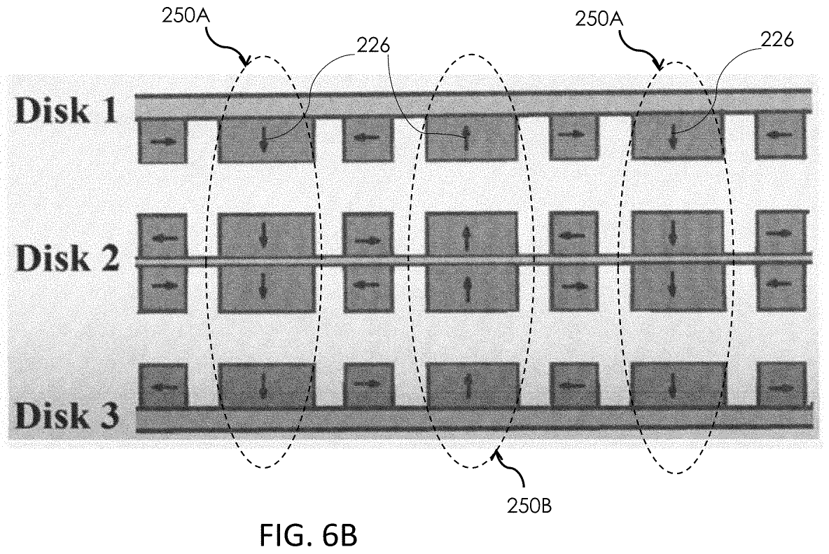

As shown in FIG. 6A, the dynamic recapture configuration positions the magnets in such a way that the magnetic fields are reversed and collapse back on itself as shown in FIG. 6B to increase the charge produced instead of simply expanding out into infinity until the fields dissipate.

FIG. 6A depicts a cross-sectional view of a Dynamic Recapture Magnetic Field Structure in the assembly 200 of FIGS. 4, 5, and showing alignment of magnet fields 250 of the rotor in a north south configuration where the first disc 212 represent inner stator coil, a second disc 214 is a two-sided rotor and having magnets on each rotor surface and a third disc 218 representing the second stator coil.

In FIG. 6A, magnetic field lines 250 naturally bunch together in regions where the magnetic field is the strongest. This means that the density of field lines indicates the strength of the field. Magnetic field lines are closed loops and will continue inside a magnetic material. By placing the magnets in the dynamic recapture structure, using a dynamic recapture method, the magnetic repulsion of the magnets are used to concentrate the magnetic field strength and maximize the electric field and achieve maximum charge generation at the stator windings.

FIG. 6B depicts a further conceptual cross-sectional view of a Dynamic Recapture Magnetic Field Structure in the assembly 200 of FIGS. 4, 5, and in particular, the alternating magnetic field directions 250A, 250B induced by interaction of first disc 212 (the first coil magnet in the series), second disc 214 (the second magnet in the series) and third disc 218 which is the third magnet in the stator-rotor-stator (three disk) series. FIG. 6B conceptually represents the interaction of the stator coils with each individual magnets of the rotor, the shape and placement of the magnets on the rotor providing the mechanism that creates these alternating direction flux lines.

As shown in FIG. 6B, the magnetic field is a vector field 226 that describes the magnetic influence on moving electric charges, electric currents, and magnetic materials. The moving charge in a magnetic field experiences a force perpendicular to its own velocity and to the magnetic field. Therefore, this force can be influenced by other magnets and their placement thereof. The permanent magnet's magnetic field pulls on ferromagnetic materials such as iron and attracts or repels other magnets. In the dynamic recapture method of system 200, the repulsion force is used to cage the magnetic field and concentrate it around the copper coil of the stator. Magnetic fields surround magnetized materials and are created by electric currents such as those produced in a copper coil-winding by rotation of a permanent magnet or rotation of magnets on surfaces of the rotor, and by electric fields varying in time. Since both strength and direction of a magnetic field may vary with location as shown as magnetic field forces 250A, 250B, the precise relative positioning of these magnets can control this in accordance with a function assigning a vector to each point of space, e.g., vector field 226. The vector fields 226 in the dynamic recapture placement structure and method to control the generating of magnetic field lines 250 to achieve maximum charge generation are shown in FIG. 6B. It is understood that the term “magnetic field” is used for two distinct but closely related vector fields denoted by the symbols B and H. In the International System of Units, the unit of H, magnetic field strength, is the ampere per meter (A/m). The unit of B, the magnetic flux density, is the tesla (in SI base units: kilogram per second squared per ampere), which is equivalent to newton per meter per ampere. H and B differ in how they account for magnetization. In vacuum, the two fields are related through the vacuum permeability.

The entire assembly 200 is thus attached behind the wheel hub to a control arm structure behind the wheel assembly. Once the tire starts to roll it turns the rotor which then induces a current into both the stators, the current being maximized due to dynamic recapture placement and method. The current is then directed to the smart charge computer combiner 22 and then the removable ultracapacitor portable power source 25.

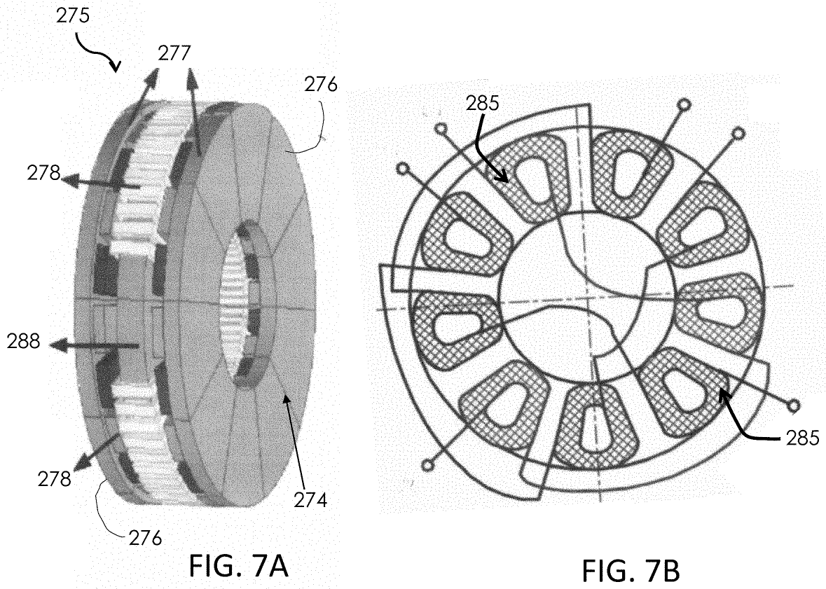

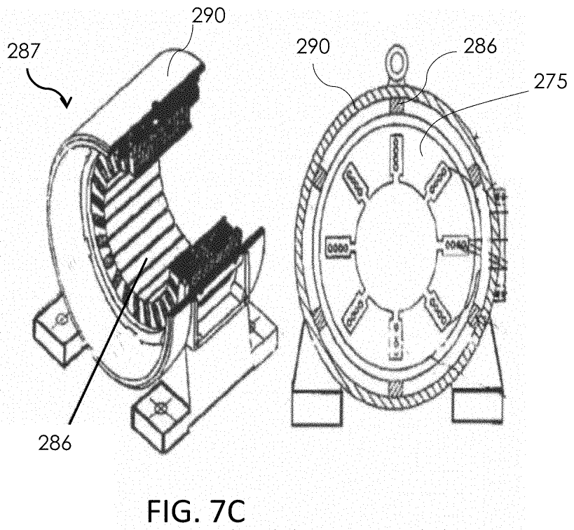

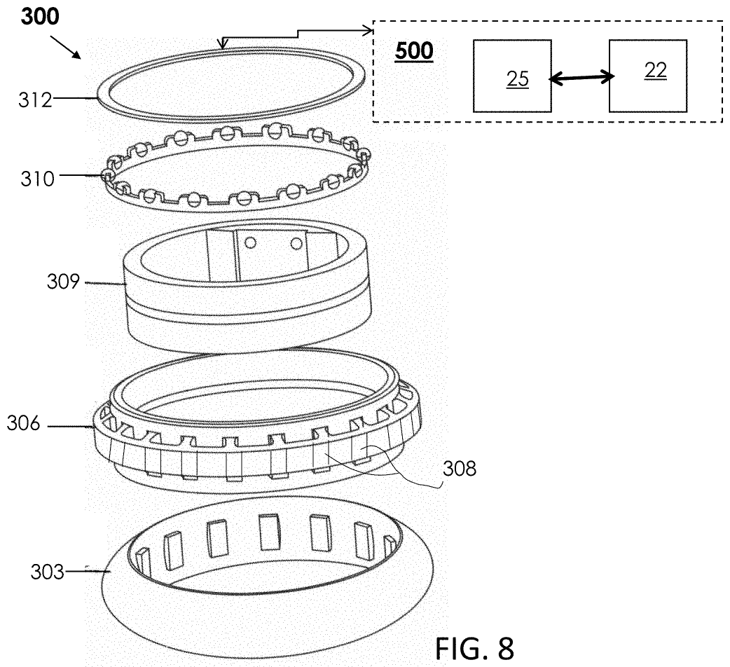

FIG. 7A shows an embodiment of a rotor assembly 275 that can be situated between three stators for use as the dynamic recapture placement structure and method to control the generating of magnetic field lines 250 as shown in FIGS. 6A and 6B to achieve maximum charge generation. In FIG. 7A, this rotor 275 is a symmetrical rotor topology that uses the entire rotor to create magnetic flux inducing current. This symmetrical rotor topology is configured as a housing having Permanent Magnets (PM) 278 placed on the entire outer peripheral edge 288 of the rotor and includes PMs 277 placed on both outer rings 276 of the rotor in a spoke type arrangement. This spoke type rotor arrangement of PMs 277 achieves the highest current volume based on size. This is a flux concentrating rotor 275 that makes the most efficient use of the rotational energy of the rotor. There is a uniform air gap length across each axis 274 and the PM maximum energy is derived by placing flat pancake copper coils directly across from the spoke type PMs and continuous ribbon copper coil stators along the rotor periphery (not shown in FIG. 7A), thereby achieving an enhanced linear current density. This rotor 275 is a spoke-type permanent magnet generator machine featured by spoke-type symmetrical Permanent Magnets (PM) 277 in a symmetric flux barrier structure. In an embodiment, the rotors are placed in a thin carbon polymer housing which holds the magnets in such a way as to allow both sides of the magnets to be exposed and holds the periphery magnets in place along the edges of the rotor. The entire design of the rotor device 275 is referred to as a flux barrier structure because the stators (not shown) surrounding the entire rotor 275 leaving no gaps in the magnetic field that are not inducing current. The stators provide a barrier for the magnetic flux.

The rotor topology used is a comprehensive complete surface mounted PM rotor, using rectangular blocks 278 with a well-defined height and width, along and across magnetization, respectively for the outer peripheral edge of the rotor and spoke-type magnets on both sides. Here, the rectangular blocks 276 are along the length of the magnet and across magnetization, i.e., across to the magnetic field right beside it, each magnetic field stretches the length of the magnet and also the sides interact with the magnet beside it. The complete surface mounted PM rotor consists of an open back carbon ceramic polymer support ring 276 housing to hold the PMs in place which allows the magnets to induce current in both the stators on either side of the rotor and the stator surrounding the rotor 275. The PMs 277 are curved to give a constant mechanical air gap length in front of the PMs. The curvature is the same on both curved sides, and the straight sides are parallel, such that the cross-sectional area is consistent. This spoke type PM rotor, also called tangential or circumferential PM rotor 275, additionally consists of a ring formed by PMs of alternating, tangential magnetization, separated by magnetically soft pole pieces (not shown) that guide the magnetic flux into the air gap. The design of one Grayson rotor of this type is shown in FIG. 7A and is described as suitable for use with neodymium (e.g., Nd—Fe—B) PMs. Pole pieces are sized to fill up the gap or space 274 between the PMs 277, starting at a slightly larger radius than the inward face of the PM and extending to the rotor periphery. To avoid flux leakage between the poles at the rotor periphery, there is a slot in the rotor surface with the PM at the bottom.

The high current output enhancement allows the rotor generator device to maximize the rotational magnetic force of the rotor due to the magnetic-field-stacking effect in the structure of rotor 275, which reduces the effects of rotor flux barrier dimensions on maximum current. It gives constant power, performance, and flux density with this optimal design. This dynamic recapture rotor topology is optimized for high volume current production in limited space. This generator device uses the entirety of the rotor surfaces not just the face of the rotor as in traditional motors and generators and this approach increases the current output of the device generator up to 2.5 times when compared to using a normal rotor.

FIG. 7B depicts a manner in which the PM maximum energy is derived by placing flat pancake copper coils 285 within the rotor housing and directly across from the spoke type PMs, thereby achieving an enhanced linear current density. The rotor design proposes a novel spoke-type permanent magnet generator machine featured by spoke-type symmetrical Permanent Magnets (PM)(100) in a symmetric flux barrier structure. The entire design of the rotor device is called the flux barrier structure because the stators surround the entire rotor leaving no gaps in the magnetic field that are not inducing current. The stators provide a barrier for the magnetic flux.

FIG. 7C depicts a third stator assembly 287 providing an outer casing 290 and an inner surface circumferentially mounting continuous ribbon copper coil stators 286. The casing encloses and encapsulates the rotor 275 such that the peripheral magnets 278 on the outside periphery of the rotor 275 interact with the ribbon copper coil stators 286 in the dynamic recapture method. The third stator assembly of FIG. 7C further depicts an assembled structure showing how the periphery magnets of the rotor 275 of FIG. 7A is surrounded by a stator assembly 287. The opposing sides of the 275 rotor are surrounded by first and second flat pancake stators (not shown). FIG. 7C further depicts in a cross-section view the manner in which the PM maximum energy is derived by placing continuous ribbon copper coil stators 286 along the rotor periphery, when the sides and the periphery stators are enclosed in the device casing it encapsulates the entire rotor 275 thereby achieving an enhanced linear current density.

FIG. 8 shows an exploded view of a third system (System 3) Hub-less Tire Generator (HTG) device 300 consisting of outer wheel rotor 303, Inner copper coil stator 306, Bearing ring 309, outer ring 310, and cap 312.

The System 3 Hub-less Tire Generator (HTG) assembly 300 is configured such that the device is built into a hub-less tire. The permanent magnet or copper coil rotor having magnets is located in the wheel outer rim. As the tire turns it rotates the rotor 303. As the rotor turns it rotates relative to the copper coil or stator 306, e.g., having copper coil-windings 308 in spaced apart configuration around a circumferential surface of the ring stator 306 depending on configuration. The generator device 300 is held in place by a bearing inner ring device 309 which is secured by a bearing outer ring 310 and cap 312.

As further shown in FIG. 8 is the smart charge controller/combiner 22 for receiving generated electrical energy, and the smart ultracapacitor 25 for storing generated charge housed in the power box 500 in an embodiment. Once the vehicle tires start to rotate it turns the rotor. The rotor then induces a current into the copper coil-windings 308 as it rotates around the stator copper coil 306. The generated current is then directed to the smart charge/combiner 22 and the smart ultracapacitor 25 which can be located in the removable/portable power box 500.

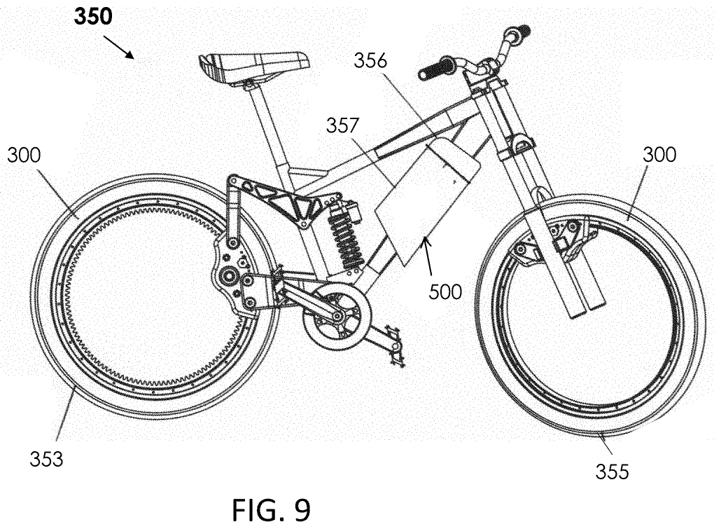

FIG. 9 depicts an electric powered vehicle such as an electric bicycle 350 equipped with an assembled System 3 Hub-less Tire Generator (HTG) device 300 of FIG. 8. In the electric bicycle 350, there is shown a rear wheel 353 with system 3 hub-less generator 300 where the entire device is enclosed and integrated within a tire rim assembly; a front wheel 355 also with a system 3 generator 300 enclosed within the rim assembly a smart charge controller/combiner 356 and smart portable/removable ultracapacitor 357 energy storage unit that is housed in a removable/portable PowerBox unit 500 containing the removable ultracapacitor energy storage device that can be used to power other vehicles, appliances, equipment or other devices.

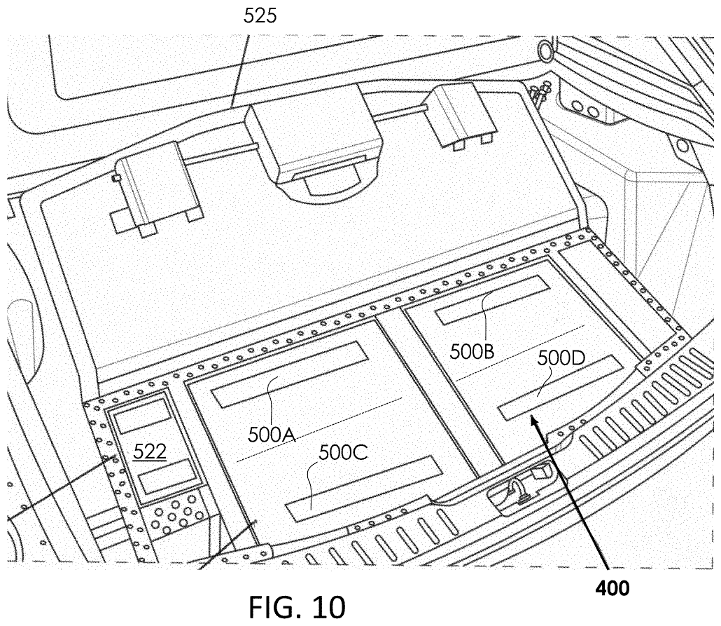

FIG. 10 depicts a portion of an electric powered vehicle equipped with a Grayson PowerBox Trunk Unit 400. In FIG. 10 there is depicted four removable portable Grayson PowerBox units 500A, 500B, 500C, 500D which fit into the vehicle trunk 502. In FIG. 10, the trunk 400 unit fits the Grayson PowerBox removable power storage devices 500A, . . . , 500D, a charge computer controller and combiner 522. Each of the powerboxes 500A, . . . , 500D and the charge computer controller and combiner 522 are protected by a folding or retractable trunk unit lid 525.

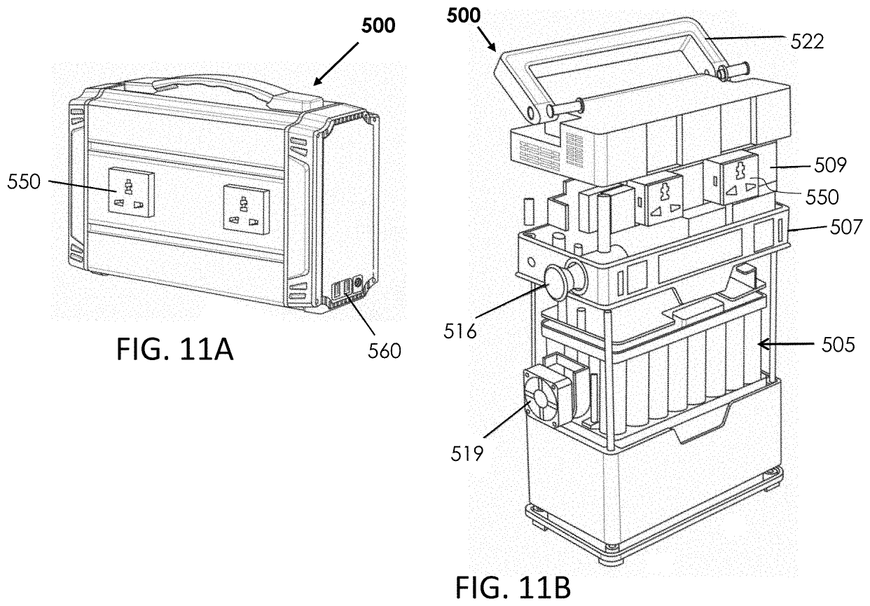

FIG. 11A depicts a view of the Grayson PowerBox 500 wherein the device has multiple electrical sockets 550 including AC or DC electricity depending on the configuration to plug in appliances, equipment, and accessories. The powerbox device 500 includes an interface or like electrical circuit adaptors or connectors 560 designed to plug into complementary electrical connectors in both the trunk unit 400 of FIG. 10 and a home unit (not shown). In an embodiment, the charge system 1, system 2 or system 3 vehicle generators have outputs that are combined by a charge combiner and the connection 560 connects to the charge combiner to receive power from the first electrical and second electrical machine generator outputs for storing charge at the ultracapacitors within the box 500. Alternatively, the charge system 1, system 2 or system 3 vehicle generators have outputs that can directly interface with the potable unit through the electrical circuit connectors 560 device connected to outputs of the generator systems, for receiving the power which charge is stored in the ultracapacitors within the box 500. The connector 560 may further connect to provide stored charge at the ultracapacitors for powering the battery or battery pack of the same vehicle. Once sufficient charge has been stored, e.g., according to the charge storage capacity of the ultracapacitors, if there is a surplus charge in the portable unit this surplus charge can be delivered and used for charging vehicles, devices and/or other energy use purposes, e.g., power an appliance. Stored charges can also be depleted if a vehicle's battery still has charge. Once the powerbox unit 500 is plugged back into the trunk unit 400 of a car and start driving the car, the PowerBox unit will recharge itself. The combiner and charge computer or processor in this device are configured to ensure that whatever device is used has the proper voltage and current.

FIG. 11B depicts an embodiment of Grayson PowerBox 500 including the provision of plural ultracapacitor storage devices 505 for storing energy produced by the generator system(s), charge computer controller 507, multiple socket connections 509 from ultracapacitors to sockets 550, a carrying handle 522, a charge cable connection 516 from which an attaching cable can be used to interface, connect and provide power to another device such as a home appliance, and a cooling fan 519 configured to ensure safe operating temperature conditions during charge storage and electricity charging operations.

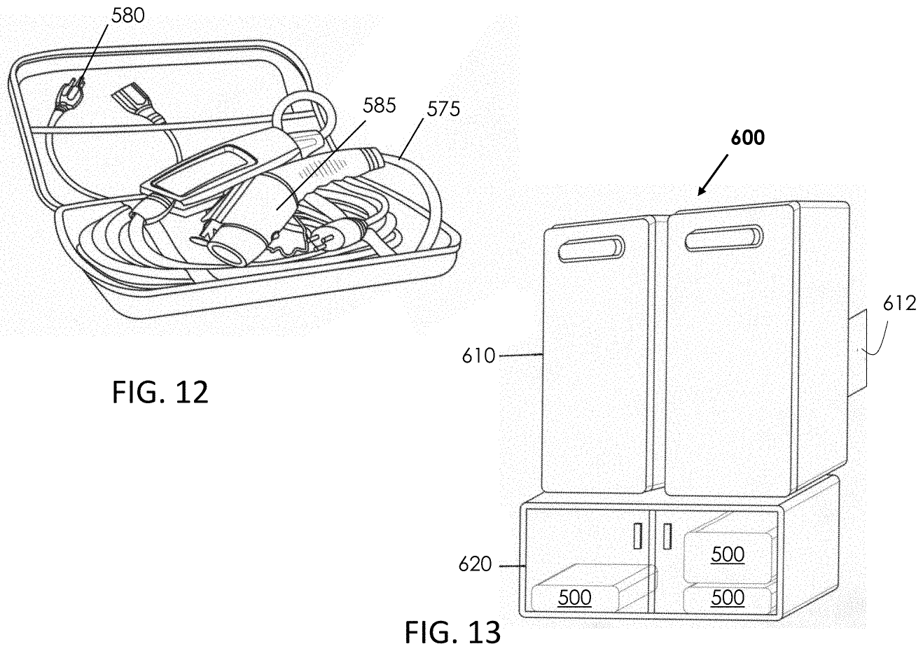

FIG. 12 shows a Grayson PowerBox charge cable extension cord 575 which is a universal charge cable having one end 580 adapted to be connected to a powerbox socket 550 and having a second end with a suitable probe or connector 585 adapted for connection to another vehicle or device to recharge other vehicles/devices.

FIG. 13 depicts a System 4 Grayson Nano Grid (GNG) apparatus 600 with Grayson PowerBox battery storage system 610 for a home unit that allows for power inputs, e.g., received from vehicles and other additional power sources such as solar, wind, etc. or inputs to allow receipt of a probe or adapter e.g., from a cable attached to the removable/portable powerbox unit 500. The GNG apparatus 600 can power a home, recharge powerbox units 500, and/or return power to the grid, e.g., a nano grid, used to power any other buildings that are connected to a nanogrid electrical network. As shown, the apparatus 600 includes an enclosure 620 for housing multiple removable/portable PowerBox units 500 and further includes a charge hose receptacle 612 for receiving a charge cable connection, e.g., when connected to another power source.

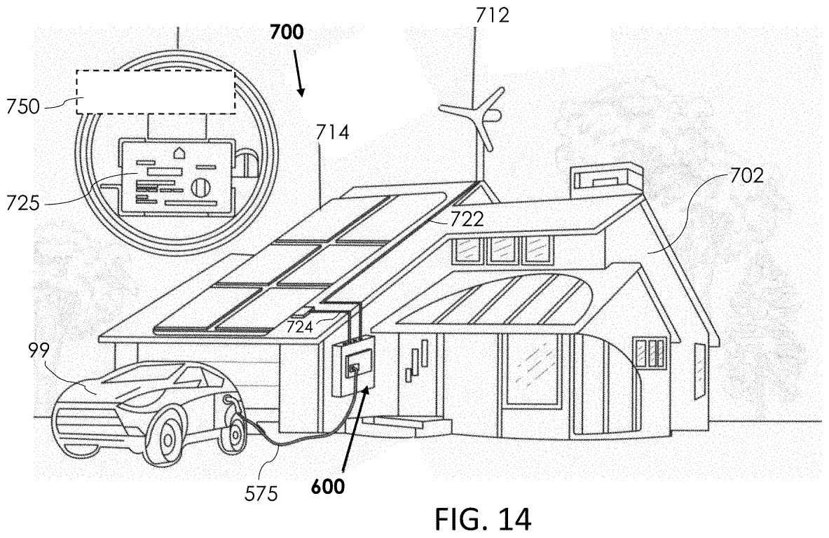

FIG. 14 depicts a home 702 equipped with a Grayson Nano Grid (GNG) system or GNG unit 700 employing PowerBox and/or home PowerBox unit 600 of FIG. 13. In an embodiment, NanoGrid unit 700 makes a personal home 702 part of an electrical system or nanogrid community. This nanogrid system 700 only services members of a networked grid system. The device 700 allows users to request and receive or dispense energy to other members of the grid network. In an embodiment, shown in FIG. 14, wind energy input produced by and received from a wind power generator 712 is accepted by the home unit 600 via cabling and connector 722. Likewise, solar energy input produced by and received from a solar power generator including solar panels 714 is accepted by the home unit 600 via cabling and connector 724. In an embodiment, the nanogrid unit 700 operates under computer or processor controller 725 that allows the unit to communicate with and/or exchange power between other units corresponding to other members that are part of a nanogrid network 750.

In an embodiment, a further system (System 4) is the Grayson Nano Grid (GNG) 700 is configured such that the powerbox unit 500 device becomes a mobile power station that powers the vehicle 99 and other devices. The power created by the generators is directed to the smart charge computer combiner ultracapacitor device, which is located in various location, including but not limited to, various locations on a bike or electric vehicle wheel or wheel assemblies, the housing unit 600, or in the trunk unit 400 of the vehicle. The smart charge computer component regulates and controls the charge coming from all power inputs from the multiple kinetic generators such as system 1 (CHG) center hub generator 100, system 2 (RHG) rear hub generator 200 and system 3 (HTG) hubless tire generator 300, the smart combiner which combines all of the charge inputs from each of these multiple kinetic generators into a single charge and voltage, the at least two removable ultracapacitor storage units which can deliver both DC and AC power using a built in inverter/rectifier device (not shown). A rectifier is an electrical device that converts alternating current (AC), which periodically reverses direction, to direct current (DC), which flows in only one direction. The reverse operation (converting DC to AC) is performed by an inverter. The powerbox unit 500 combines both of these systems.

The portable units 500 can be removed from the vehicle to power other vehicles, provide the power source of the home unit 600, or used as a portable generator to power appliances, equipment, and small devices remote from the vehicle or home. Once the vehicle PowerBox unit 500 is removed it can be plugged into the home-based nanogrid storage unit 600. The nano grid home unit 600 can be used to power the home, send power to the grid such as a nanogrid network 750, the community, or other vehicles. The home unit 600 can accommodate multiple PowerBox units 500 and can receive inputs from various other power sources including but not limited to solar or wind. This device 500 is the centerpiece of the personal nanogrid. This device communicates with other members of a nanogrid system, other homes or buildings in a neighborhood or village. The system can request power from other members in the case of blackouts or other power failure crisis. The device can also allow for multiple power inputs both AC and DC. Then the system allows for the powering of a home or car as well as use the portable PowerBox 500 to power appliances, equipment, or other devices. The device allows a user to sell power back to the grid to aid in times of high grid usage during peak hours. Using this system, it is possible to store energy during low peak hours, e.g., during non-peak usage hours, e.g., ranging from about 10:00 PM-5:00 AM, or use energy or sell the energy back during high peak hours at a premium. making this an additional source of revenue to offset homeowner expenses.

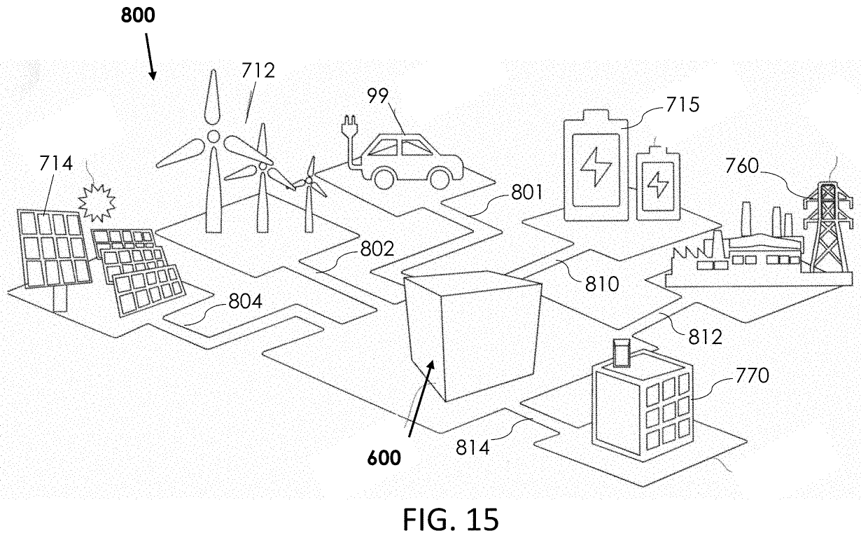

FIG. 15 depicts a Grayson Nano Grid management Network (GNG) 800 employing the PowerBox home unit 600 configured to receive input from generator units or provide power to the battery or powerbox unit 500 supplied in vehicle 99 via conductor 801, receive a power input via conductor 802 from Wind power generators 712, and receive a power input via conductor 804 from solar power generators 714. Subsequently, PowerBox home unit 600 can provide output energy via conductor 810 to another storage unit such as storage battery/packs 715, e.g., in other vehicles, or mobile recharging units; can provide or return output power via conductor 812 to the electric grid, e.g., grid network 760, and/or provide or return output power via conductor 814 to a community grid share or to power a secondary building 770. Powerbox Home or NanoGrid unit 600 is thus the centerpiece of a personal nanogrid. This device communicates with other members of the nanogrid system, other homes or buildings in a neighborhood or community.

As an example, once an adequate charge supply is obtained, the home unit 600 can reduce a dependence upon receiving power from the grid and allow for off peak usage of the grid. Each nanogrid can be linked to other nanoGrids to create community based mini-grids. This configuration stores the maximum power, and the entire device is controlled by a computer control system that monitors the entire operation for efficiency, performance, and optimization.

The system 800 can request power from other members in the case of blackouts or other power failure crisis. The device also allows for multiple power inputs both AC and DC. Then the system allows a user to power a home or electric vehicle or car as well as use the portable PowerBox to power appliances, equipment, or other devices. The device allows users to sell power back to the power grid, e.g., to aid in times of high grid usage during peak hours. This entire system 800 is controlled by a computer-controlled power management system that monitors the entire operation for efficiency, performance, and optimization.

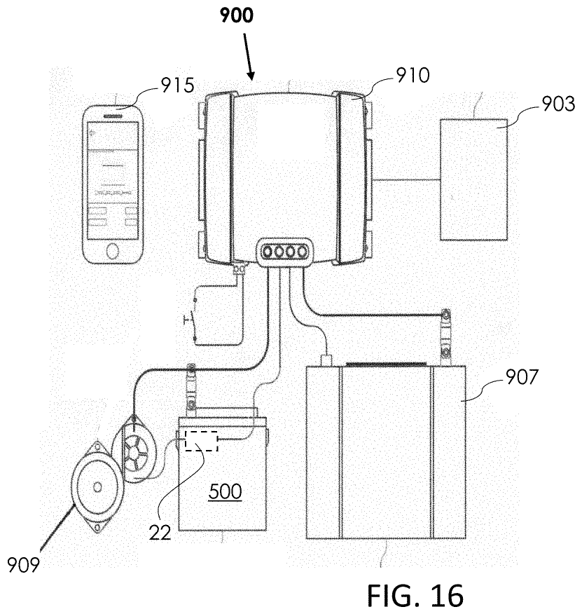

FIG. 16 shows an embodiment of a Smart Charge Controller system 900 for a vehicle to store charge generated by one or more charge generator system 100 (FIGS. 1, 2), 200 (FIG. 4) or 300 (FIG. 8) in a vehicle. The Smart Charge Controller system 900 includes an ultracapacitor storage device 910 and further includes a smart charge controller or control processor device 903, the smart ultracapacitor 910 and a wireless remote control monitoring device 915. As shown the ultracapacitor storage device 910 can receive charge from the vehicle charge generator systems 100 (FIGS. 1, 2), 200 (FIG. 4) or 300 (FIG. 8) directly from the vehicle wheels or wheel assemblies 909, and/or provide/receive power to/from a directly connected Battery pack 907 and/or a PowerBox unit 500 of the vehicle or another vehicle

Thus, in view of the Smart Charge Controller system 900 of FIG. 16, for example, a vehicle or powerbox unit 500 within the vehicle can include a hardware-processor or computer-based control system configured to control each of the generation systems (CHG), (RHG), (HTG), etc., in a normal operational state wherein the generated charges received from multiple inputs are combined into a smart charge combiner 22. This combiner device further combines the multiple inputs connected to various generator outputs and charge inputs into a single voltage and current for storage, or otherwise, controls the charges from multiple inputs and directs the flow of electricity to an appropriate system at the appropriate voltage. In embodiments, the hardware-processor or computer-based control system is configured to control the energy generation system(s) and combine charge inputs and direct the charge to a smart high capacity self-cooling ultracapacitor 910. The ultracapacitor 910 can also receive fast charging from other powerbox units 500. In addition, the ultracapacitor 910 can fast charge other devices, e.g., trickle charge the battery pack 907 to prevent degradation and overheating. This system 900 is a self-cooled system and can also power other vehicles directly at appropriate voltage and current requirements.

In an embodiment, the hardware-processor or computer-based control system is configured to control the kinetic recharger generator system, charge combiner and ultracapacitor storage system while the vehicle is being driven such that the generated electricity can be routed for storage at the ultracapacitor storage system. The control system is further configured to control the system wherein the charges stored in the ultracapacitor can be delivered as electricity to charge another device, e.g., an appliance, a home, or an electrical network (nanogrid) using a charging cable connected to the Powerbox (portable energy storage unit).

Each of the redundant electrical energy generation systems for the electric vehicle is super-efficient and computer controlled having a charge controller which is all completely concealed by the body of the vehicle. The magnetic fields are created through electric current in a wire-wound coil at the stators of the two-stator charge generator system. Each device passes the charge to the combiner which in turn passes the current to the smart ultracapacitor storage devices of the powerbox unit 500 which is then used to charge a myriad of other devices, e.g., the same vehicle or other vehicles, a battery bank, a nano-grid, an appliance. Beneficial effect of the embodiments described herein include, but are not limited to:(1), system increases the range of an electric vehicle up to 200%; (2) compared with traditional range extenders this device requires no additional fuels; (3), compared with traditional generators this device has much greater charging capacity and reliability; (4), compared with other types of recharging systems like regenerative breaking and diesel-powered range extenders, this system has lower coefficient of friction, generates an exponentially higher amount of electricity and is infinitely more reliable; (5) can be very applicable and installed on all existing electric vehicles; (6) compared to other range extenders this device lowers the sprung weight of the vehicle; and (7) compared to other range extenders this device has zero emissions.

The description of the invention has been presented for purposes of illustration and description, and is not intended to be exhaustive or to limit the invention in the form disclosed. Many modifications and variations will be apparent to those of ordinary skill in the art without departing from the scope of the invention. The embodiments were chosen and described in order to explain the principles and applications of the invention, and to enable others of ordinary skill in the art to understand the invention. The invention may be implemented in various embodiments with various modifications as are suited to a particular contemplated use.

What is claimed is:

1. A power generation system for an electric or hybrid vehicle, said power generation system comprising:
one or more first electrical machine generator systems connected at a center hub of a corresponding one or more rotating wheels of the vehicle, each respective one or more first electrical machine generator systems for generating electricity responsive to kinetic energy of the respective corresponding rotating wheel; and
one or more second electrical machine generator systems connected at a tire rim assembly of a corresponding one or more rotating wheels of the vehicle, each respective one or more second electrical machine generator systems for generating electricity responsive to kinetic energy of the respective corresponding rotating wheel; and
an energy storage and delivery system adapted to receive generated electricity from each of the one or more first electrical machine generator systems and second electrical machine generator systems, store said generated electricity as charge corresponding to concentrated voltage or current received from said first electrical and second electrical machine generators and deliver stored charge as electric power for use by the vehicle.

2. The power generation system as claimed in claim 1, wherein the energy storage and delivery system comprises:
a charge combiner controllable by a processor device to receive multiple power inputs from one or more said first and second electrical machine generator systems and concentrate the received power input into a single voltage or current; and
a self-cooling ultracapacitor storage device controllable by the processor device to receive, store and deliver said single voltage or current.

3. The power generation system as claimed in claim 2, wherein a first electrical machine generator comprises an assembly having:
an outer ring stator having a metal coil winding in a first position;
an inner ring stator having a metal coil winding in a second position and a periphery ring stator having a metal coil winding in a third position;
a center ring rotor disposed between the outer ring, inner ring, and periphery stators; and
a harness for locating the assembly into a center portion of a wheel of the vehicle, wherein the center ring rotor is configured to rotate as the vehicle wheel rotates, said center ring rotor adapted to induce a charge in the inner stator ring, the outer ring, and the periphery stator ring response to rotating motion of the wheel.

4. The power generation system as claimed in claim 3, wherein the outer ring stator and inner ring stator are positioned in parallel and the first position and second position is phased relative to each other to maximize charge induction.

5. The power generation system as claimed in claim 4, wherein the phased position comprises:
a position of a metal coil winding of the outer ring stator out of direct alignment with a position of a metal coil winding of the inner ring stator so as to maximize the force exerted against them by the rotor and thereby maximize the charge produced.

6. The power generation system as claimed in claim 4, further comprising:
a pulse generator circuit for generating pulses, said metal coil winding of the outer ring stator responding to said pulses to one of: induce a current to flow in the outer ring stator while preventing current flow in the inner stator ring, or induce a current to flow in the inner ring stator while preventing current flow in the outer stator ring.

7. The power generation system as claimed in claim 2, wherein a further first electrical machine generator comprises an assembly having:
a first ring stator having a metal coil winding;
a second ring stator having a metal coil winding;
a third ring stator having a metal coil winding;
a center rotor situated between the first ring stator, second ring stator and the third ring stator, the rotor having magnets situated on front, back and periphery surfaces thereof to induce charge in metal coil windings of the first ring stator, second ring stators and the third ring, and the rotor magnets configured to dynamically recapture a produced magnetic field by forcing the produced magnetic field to collapse back on itself and maximize an electric field; and
a harness for affixing the assembly at a control arm of the wheel assembly of the vehicle.

8. The power generation system as claimed in claim 7, wherein the center rotor is configured to rotate as the vehicle wheel rotates, said center rotor adapted to induce a current in all three metal coil windings of an inner stator ring, a metal coil winding and of an outer stator ring and a metal coil winding of the periphery stator ring, responsive to rotating motion of the wheel, the induced current being conveyed to said charge combiner for storage in the self-cooling ultracapacitor.

9. The power generation system as claimed in claim 7, further comprising:
a shim spacer element for electronically controlling a spatial distance between the rotor and the first ring stator and second ring stator, the shim spacer controllable by the processor device to electronically adjust the spatial distance between the rotor and each said first ring stator and second ring stator to maximize induced current.

10. The power generation system as claimed in claim 2, wherein a further first electrical machine generator comprises a hubless wheel assembly having:
an outer rim, the outer rim comprising a rotor that rotates as the wheel rotates;
a stator situated proximate the stator comprising a metal coil winding, the outer stator responding to outer rim rotation by inducing current within said metal coil winding, the induced current being conveyed to said charge combiner for storage in the self-cooling ultracapacitor.

11. The power generation system as claimed in claim 2, wherein the energy storage and delivery system is a portable energy storage unit comprising the self-cooling ultracapacitor storage device storing charge, said portable energy storage unit having a housing adapted for physically attaching to and removing the portable energy storage unit from the vehicle.

12. The power generation system as claimed in claim 11, wherein the portable energy storage unit comprises:
a first electrical connector for electrically connecting the portable energy storage unit to another device and adapted to deliver current from said stored ultracapacitor storage device to the another device under control of the processor, or receive electrical current for storage into said stored ultracapacitor storage device from the another device under processor control.

13. The power generation system as claimed in claim 12, wherein the portable energy storage unit comprises:
a second electrical connector for electrically connecting the ultracapacitor storage device of said portable energy storage unit to the charge combiner for receiving power at said portable energy storage unit from said first electrical and second electrical machine generator outputs.

14. The power generation system as claimed in claim 12, wherein the electric or hybrid vehicle comprises:
a compartment for housing one or more portable energy storage units, the compartment having respective complementary electrical connector devices that electrically connect with respective second electrical connectors of respective portable energy units to receive power from said first electrical and second electrical machine generator outputs.

15. The power generation system as claimed in claim 12, wherein said one or more portable energy storage units are removed from the vehicle to power the another device via said first electrical connector, said another device comprising one or more of, an appliance, an equipment, accessories, another electric vehicle, a building power supply system, an electrical network or grid.

16. The power generation system as claimed in claim 12, wherein said one or more portable energy storage units electrical connect with a battery charging system for charging a battery or battery pack of the vehicle or of a different electric vehicle.

17. A portable power supply system comprising:
a portable energy storage unit adapted for storage in a vehicle and removal from the vehicle, the portable energy storage unit comprising:
a self-cooling ultracapacitor energy storage device controllable by a hardware processor device to receive and store electricity received from multiple redundant energy recharger devices disposed in a vehicle that convert kinetic energy of a respective rotating vehicle wheel into generated electricity;
a first electrical connector for electrically connecting the ultracapacitor energy storage device to an output of the multiple redundant energy recharger devices for receiving the electricity generated from multiple redundant energy recharger devices at the respective rotating vehicle wheel; and
one or more second electrical connectors for electrically connecting the portable energy storage unit to another device, said portable energy storage unit adapted to power up another device by delivering stored charge from the ultracapacitor storage device the portable energy storage unit is to the another device when the portable energy storage unit is removed from the vehicle.

18. The portable power supply system as claimed in claim 17, wherein said multiple redundant energy recharger devices disposed in the vehicle comprises:
one or more first electrical machine generator systems connected at a center hub of a corresponding one or more rotating wheels of the vehicle, each respective one or more first electrical machine generator systems for generating electricity for storage in said self-cooling ultracapacitor storage device responsive to kinetic energy of the respective corresponding rotating wheel; and
one or more second electrical machine generator systems connected at a tire rim assembly of a corresponding one or more rotating wheels of the vehicle, each respective one or more second electrical machine generator systems for generating electricity for storage in said self-cooling ultracapacitor storage device responsive to kinetic energy of the respective corresponding rotating wheel;

19. The portable power supply system as claimed in claim 17, wherein said one or more portable energy storage units are removed from the vehicle to power the another device via said second electrical connector, said another device comprising one or more of, an appliance, an equipment, accessories, another electric vehicle, a building power supply system, an electrical network, electric grid, nano-grid or mini-grid system.

20. The power generation system as claimed in claim 12, wherein said one or more portable energy storage units electrical connect with a battery charging system for charging a battery or battery pack of the electrical vehicle or of a different electric vehicle.
